(19) United States
(12) Patent Application Publication
(10) Pub. No.: US 2007/0252357 A1
(43) Pub. Date: Nov. 1, 2007

(54) Combination loading ramp/trailer

(76) Inventor: Randall D. Hoskins, Snowflake, AZ (US)

Correspondence Address: LITMAN LAW OFFICES, LTD., P.O. BOX 15035, CRYSTAL CITY STATION, ARLINGTON, VA, 22215, US

(21) Appl. No.: 11/783,295

(22) Filed: Apr. 6, 2007

Related U.S. Application Data
(60) Provisional application No. 60/794,848, filed on Apr. 26, 2006.

(51) Int. Cl. B62D 53/06; B60P 1/04

(52) U.S. Cl. 280/415.1; 280/656; 280/789; 414/481

(57) ABSTRACT

A utility trailer that is converted from an ATV loading ramp. The loading ramp frame is adjusted to form a V-shaped trailer body. An axle and wheels are attached to the V-shaped body along with an elongate handle. The handle also functions as a hitch for connecting the wheeled V-shaped body to the ATV. A system of metal pins, bolts and brackets serve to connect the various parts of the converted device. The various parts of the device, excluding the loading ramp, can be made available in the form of a kit.

### CROSS-REFERENCE TO RELATED APPLICATION

This application claims the benefit of U.S. Provisional Patent Application Ser. No. 60/794,848, filed Apr. 26, 2006.

### BACKGROUND OF THE INVENTION

1. Field of the Invention

The present invention generally relates to transporting devices. More specifically, the present invention is drawn to an all-purpose trailer that is converted from an ATV loading ramp.

2. Description of the Related Art

Hunters and/or woodsmen often have to haul game or other objects over tracts of land that are accessible only with an ATV-towed trailer. This scenario requires that both the ATV and trailer are transported to an area adjacent the tract of land. The space taken by the ATV and trailer often prohibits the transporting of other desired paraphernalia to the tract. The art would certainly welcome a trailer that can be converted from another device so as to save transporting space. Thus a combination loading ramp/trailer solving the aforementioned problems is desired.

The related art is rife with the disclosures of utility trailers. Pertinent samples of such related art are cited and identified in the accompanying IDS. However, none of the cited and identified related art discloses a trailer converted from a loading ramp as will subsequently be described and claimed in the instant invention.

### SUMMARY OF THE INVENTION

The present invention is drawn to a utility trailer that is converted from an ATV loading ramp. The loading ramp frame is adjusted to form a V-shaped trailer body. An axle and wheels are attached to the V-shaped body along with an elongate handle. The handle also functions as a hitch for connecting the wheeled V-shaped body to the ATV. A system of metal pins, bolts and brackets serve to connect the various parts of the converted device. The various parts of the device, excluding the loading ramp, can be made available in the form of a kit.

Accordingly, the instant invention presents a trailer whose body is converted from an ATV loading ramp. The trailer is easily assembled and disassembled and is capable of hauling relatively heavy loads. When disassembled, the loading ramp is folded flat for transportation to and from the field. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a combination loading ramp and trailer according to the present invention.

FIG. 2 is a partial view showing the hitch attached to the loading ramp and trailer according to the present invention.

FIG. 3 is an exploded view of a combination loading ramp and trailer according to the present invention.

FIG. 4 is a top view of a combination loading ramp and trailer according to the present invention.

FIG. 5 is a front view of a combination loading ramp and trailer according to the present invention.

FIG. 6 is a perspective view of a second embodiment of a combination loading ramp and trailer according to the present invention.

FIG. 7 is a front view of a second embodiment of a combination loading ramp and trailer according to the present invention.

Similar reference characters denote corresponding features consistently throughout the attached drawings.

### DETAILED DESCRIPTION OF THE PREFERRED EMBODIMENTS

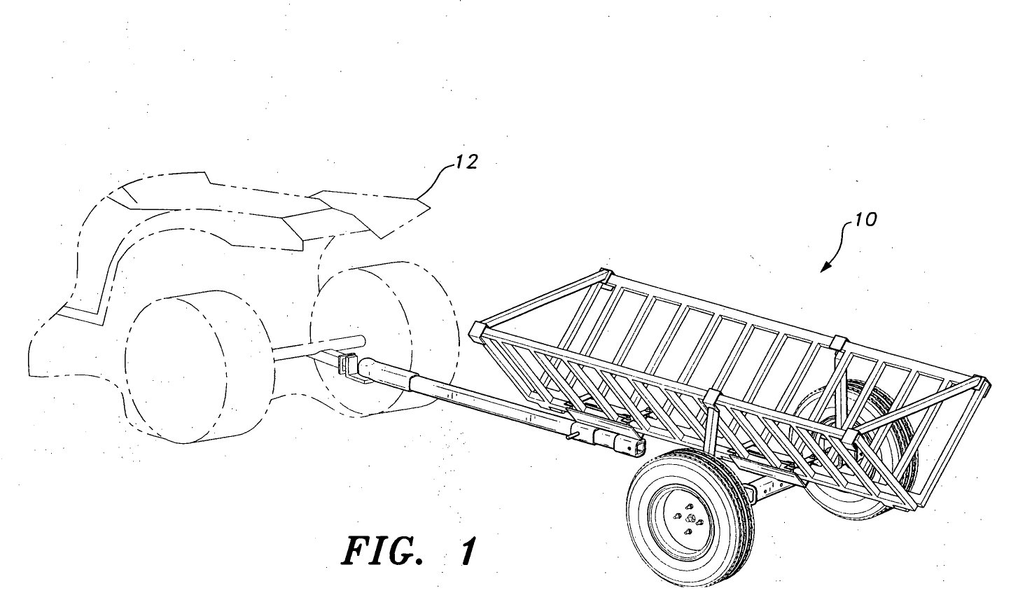

Attention is first directed to FIG. 1 wherein the present invention is generally indicated at 10. Trailer 10 is shown in its assembled state and is being towed by ATV 12.

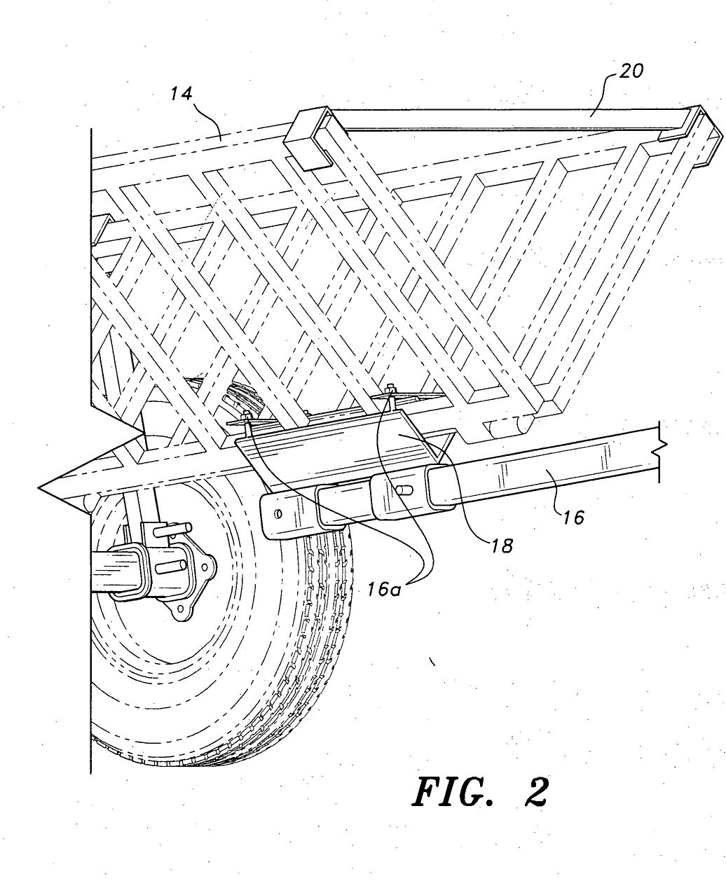

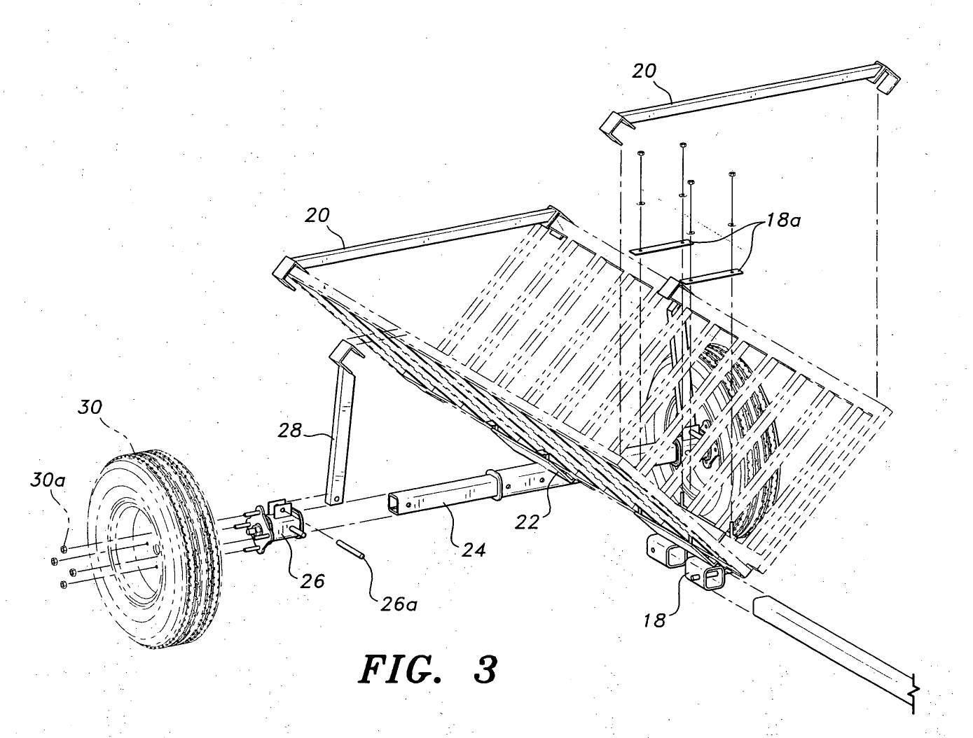

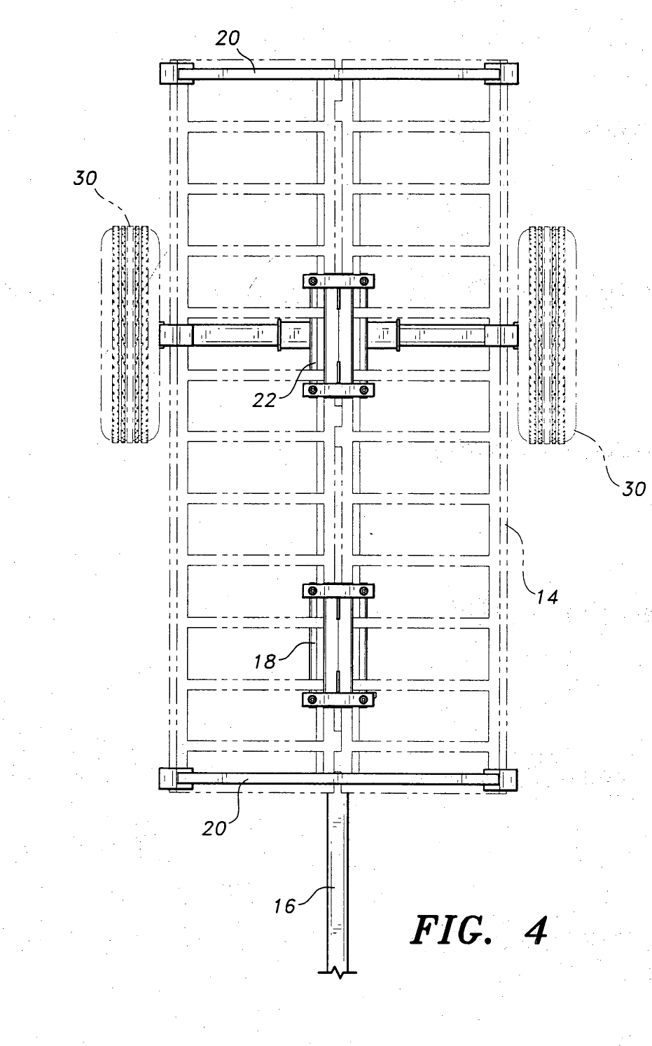

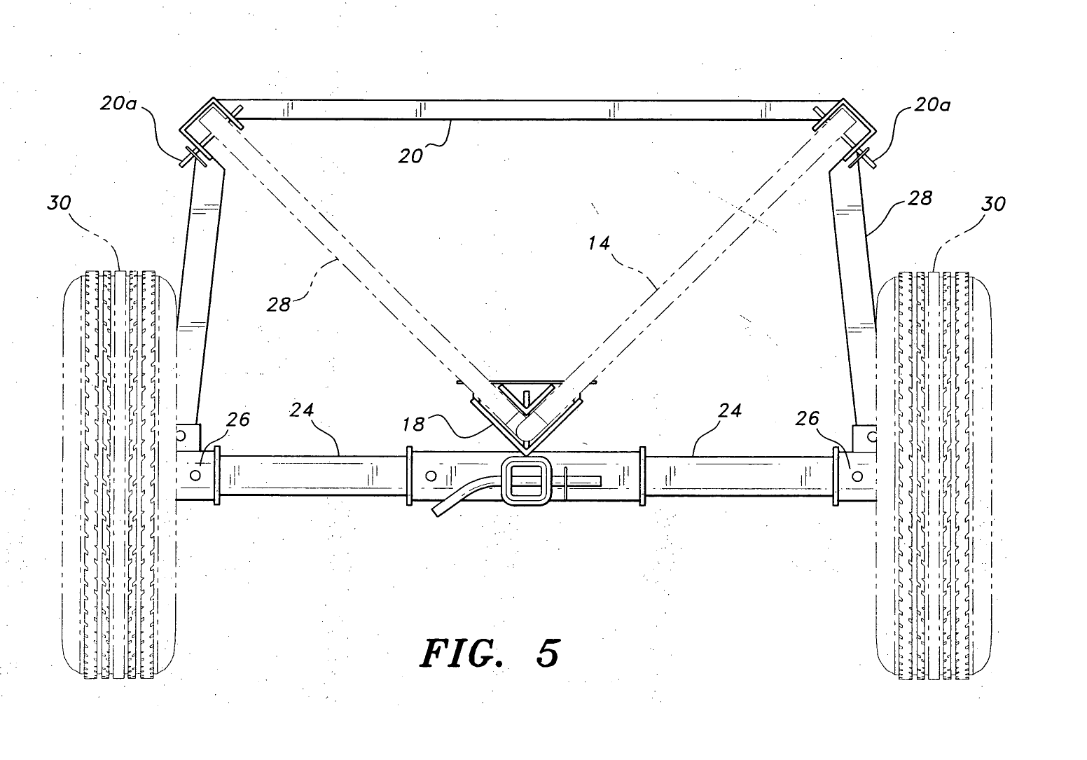

As best seen in FIGS. 2-5, a V-shaped body 14 forms the frame of trailer 10. Body 14 is a load ramp for the ATV. Although illustrated as a bi-fold ramp, it is contemplated that other ramp types (tri-fold, etc.) can be utilized to form the body. A tow hitch member 16 is attached to V-shaped body 14 adjacent the forward end thereof. A hitch clamp bracket 18 is employed attach tow hitch member 16 to body 14. Hitch clamp bracket 18 is connected to body 14 at the apex of the V. An array of nuts and bolts 16a, 18a is utilized to affect the connection. A pair of cross supports 20, fabricated from metal tubing, is utilized to provide stabilization for the body 14. Cross supports 20 span the width of the body and are attached to the body with pins 20a. An axle clamp 22 is attached to the body towards the rear end thereof. Axle clamp 22 is also attached at the apex of the V. A square axle tube 24 is inserted through axle clamp 22. Axle tube 24 defines a pair of ends. A wheel hub 26 is disposed on each respective end of axle tube 24. Hub pins 26a (only one is shown) are employed to attach hub 26 to tube 24. A pair of vertical supports 28, fabricated from metal tubing, is provided to further stabilize the frame. Each vertical support 28 has an upper end removably attached to the V-shaped body and a lower end removably attached to axle tube 24 via hub 26. Bolts 30a secure a wheel 30 to a respective hub 26.

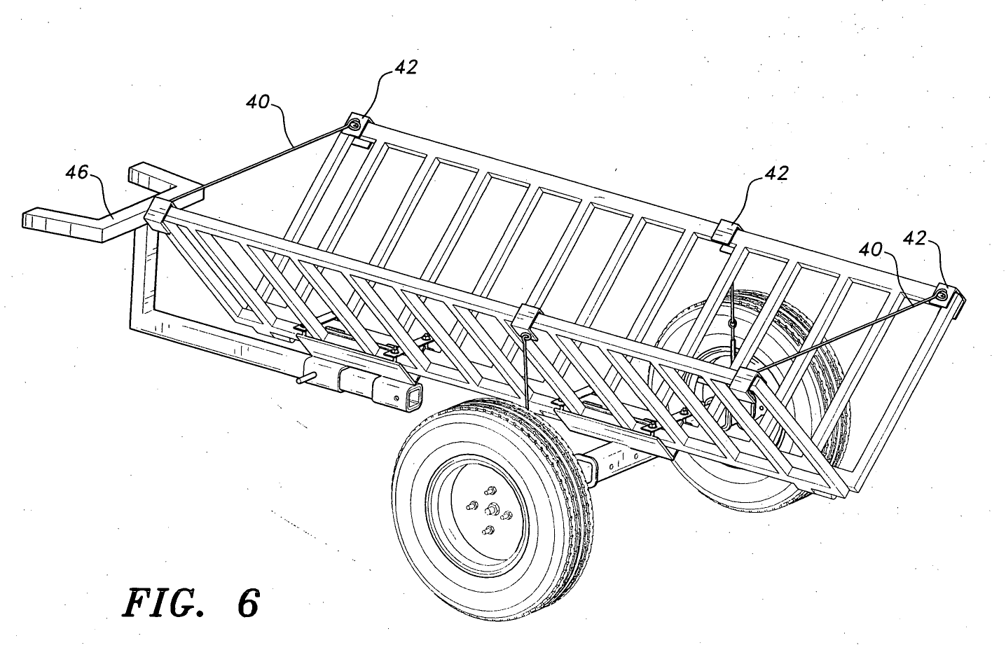

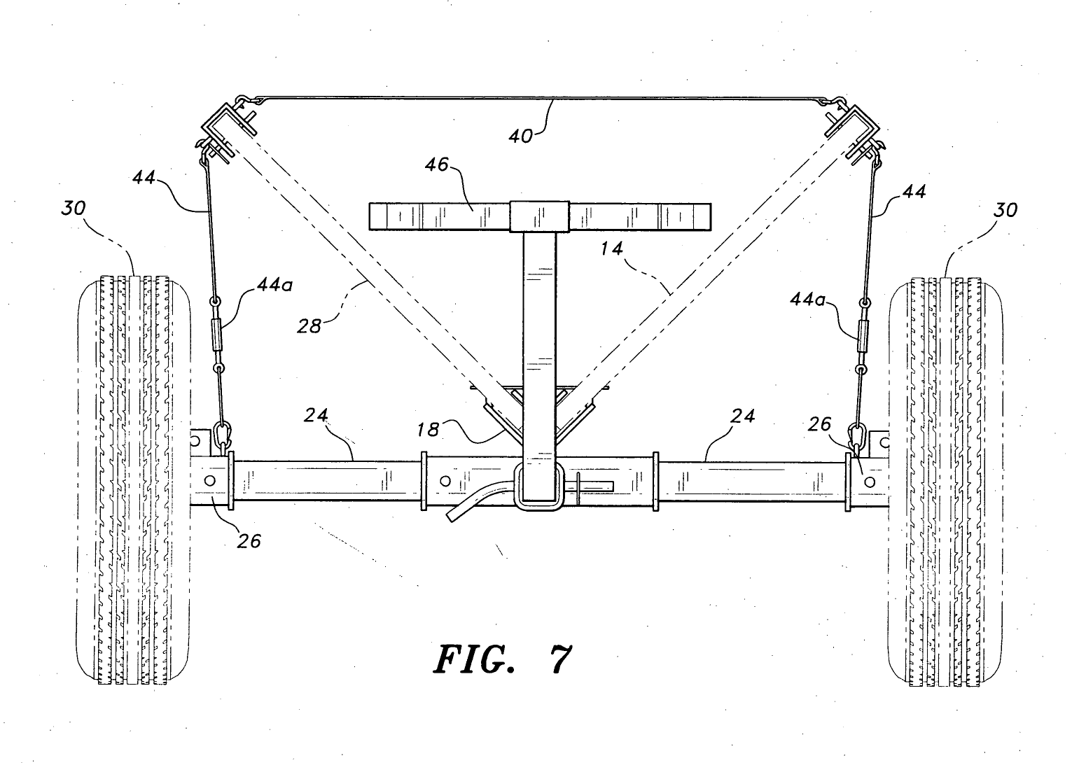

FIGS. 6 and 7 illustrate a second embodiment of the invention that is of lighter weight and therefore easier to handle and maneuver. The instant embodiment employs a pair of cables 40 as cross support members in lieu of the heavier metal cross supports 20. Clips 42 are utilized to attach cables 40 to the frame of the trailer. Vertical cables 44 are utilized to provide additional stability for the trailer. The tension of vertical cables 44 can be adjusted by means of turnbuckles 44a. A removable handle 46 can be utilized to maneuver the trailer. Spoked wheels (not shown) can be employed to if it is desired to further reduce the weight of the trailer.

As previously discussed, the various items, described above, are utilized to easily convert the ATV ramp into a trailer. It should be noted that with one wheel removed, the trailer can be tilted for loading large and/or heavy game therein.

It is to be understood that the present invention is not limited to the embodiment described above, but encompasses any and all embodiments within the scope of the following claims.

I claim:

1. A combination loading ramp/trailer, comprising:
an elongate, foldable frame member, said elongate, foldable frame member being configured as a V-shaped body having an apex;
a hitch clamp bracket attached to said foldable frame member at said apex;
an axle clamp bracket attached to said foldable frame member at said apex;
a tube axle attached to said axle clamp bracket; and
a pair of wheels rotatably disposed on said tube axle.

2. The combination loading ramp/trailer according to claim 1, wherein said elongate foldable frame member is an ATV loading ramp.

3. The combination loading ramp/trailer according to claim 1, wherein said V-shaped body has a width and including a pair cross support members spanning said width, said pair of cross support members being removably attached to said V-shaped body.

4. The combination loading ramp/trailer according to claim 1, wherein said tube axle has a pair of ends and including a wheel hub removably attached to each respective end of said pair.

5. The combination loading ramp/trailer according to claim 1, including a pair of vertical support members, wherein each vertical support member has an upper end and a lower end and wherein each respective upper end is removably attached to said V-shaped body and each respective lower end is removably attached to said tube axle.

6. The combination loading ramp/trailer according to claim 1, including a tow hitch removably attached to said hitch clamp bracket.

7. The combination loading ramp/trailer according to claim 1, including a handle removably attached to said hitch clamp bracket.

8. A combination loading ramp/trailer, comprising:
an elongate, foldable frame member, said elongate, foldable frame member being configured as a V-shaped body having an apex and a width;
a hitch clamp bracket attached to said foldable frame member at said apex;
an axle clamp bracket attached to said foldable frame member at said apex;
a pair cross support members spanning said width of said V-shaped body, said pair of cross support members being removably attached to said V-shaped body;
a square tube axle attached to said axle clamp bracket; and
a pair of wheels rotatably disposed on said square tube axle.

9. The combination loading ramp/trailer according to claim 8, wherein said elongate foldable frame member is an ATV loading ramp.

10. The combination loading ramp/trailer according to claim 8, wherein said square tube axle has a pair of ends and including a wheel hub removably attached to each respective end of said pair.

11. The combination loading ramp/trailer according to claim 8, including a pair of vertical support members, wherein each vertical support member has an upper end and a lower end and wherein each respective upper end is removably attached to said V-shaped body and each respective lower end is removably attached to said tube axle.

12. The combination loading ramp/trailer according to claim 8, including a tow hitch removably attached to said hitch clamp bracket.

13. The combination loading ramp/trailer according to claim 8, including a handle removably attached to said hitch clamp bracket.

14. A combination loading ramp/trailer, comprising:
an elongate, foldable frame member, said elongate, foldable frame member being configured as a V-shaped body having an apex and a width, wherein said elongate foldable frame member is an ATV loading ramp;
a hitch clamp bracket attached to said foldable frame member at said apex;
an axle clamp bracket attached to said foldable frame member at said apex;
a pair cross support members spanning said width of said V-shaped body, said pair of cross support members being removably attached to said V-shaped body;
a square tube axle attached to said axle clamp bracket, said square tube axle having a pair of ends;
a respective wheel hub removably attached to each end of said pair of ends;
a pair of vertical support members, wherein each vertical support member has an upper end and a lower end and wherein each respective upper end is removably attached to said V-shaped body and each respective lower end is removably attached to a respective wheel hub; and
a respective wheel rotatably disposed on a respective wheel hub.

15. The combination loading ramp/trailer according to claim 14 wherein said pair of cross support members and said pair of vertical support members are fabricated from metal tubing.

16. The combination loading ramp/trailer according to claim 14 wherein said pair of cross support members and said pair of vertical support members are fabricated from cable.

17. The combination loading ramp/trailer according to claim 16, including a respective tension adjustment turnbuckle on each one of said pair of vertical support members.

18. The combination loading ramp/trailer according to claim 16, including a tow hitch removably attached to said hitch clamp bracket.

19. The combination loading ramp/trailer according to claim 16, including a handle removably attached to said hitch clamp bracket.
